(19) United States
(12) Patent Application Publication
(10) Pub. No.: US 2003/0152207 A1
(43) Pub. Date: Aug. 14, 2003

(54) Telecommunications and cellular telephone homepage call screening control center

(76) Inventor: Kevin Ryan, Zionsville, PA (US)

Correspondence Address: Charles A. Wilkinson, Esq., 68 East Broad Street, P.O. Box 1426, Bethlehem, PA, 18016-1426, US

(21) Appl. No.: 10/075,573

(22) Filed: Feb. 13, 2002

(51) Int. Cl. H04M 3/42

(52) U.S. Cl. 379/201.04

(57) ABSTRACT

A computer operating system and arrangement by which a web site owner can control the receipt of telephone and other messages by providing menus of callers from which communication will be accepted in various manners if it is to be accepted at all. Such menus are easily altered by the web site owner in a multitude of formats and enables the one who is to receive calls to closely control from whom and in what manner he or she will accept calls from outside parties. In one embodiment of the invention the means or lists can be changed through a cell phone hook-up with the web site.

### BACKGROUND OF THE INVENTION

1. Technical Field of the Invention

This invention relates to personal communications systems and the Internet, and more particularly to a system and method for enabling a called party to personally control which communications features individual caller's are able to access, including the ability to establish a phone connection and to activate and utilize a number of call handling utilities over a packet switching network.

2. Preliminary Discussion

Traditionally, telephonic communication has taken place over a switch based telephone network, commonly referred to as a Public Switching Telephone Network, or PSTN, also sometimes referred to as POTS, or Plain Old Telephone Service. In such a system, when a call is made from a telephone or a computer, switching equipment physically routes the call to the called party's receiver. A circuit or dedicated connection is then established and is maintained until the call is ended.

One bothersome result of telephone service via the traditional PSTN network is the large number of unsolicited advertising or sales calls received from telemarketers. Many of such telemarketers use very aggressive sales tactics to try sell their products and services. Such services typically include, but are not limited to, credit card services, long distance calling services, mortgage services, as well as a myriad of fund raising activities, surveys, and the like. Although a call from a telemarketer is almost always unwanted, some consumers, not wishing to be rude, may feel obligated to at least listen to the telemarketer before ending the call. A significant number of consumers also may be pressured into agreeing to purchase something from the telemarketer, even though such consumer is not really that interested. Even more bothersome is the fact that such calls usually occur at inconvenient times, such as in the early evening or around dinnertime, and are considered by many to be a serious nuisance or even an invasion of privacy. In addition, it is well known by most consumers that some of such telemarketing calls are fraudulent, and it is often very difficult for average consumers to distinguish between legitimate and fraudulent offers. While legislation has been passed to try to limit unethical telemarketing practices, in general such legislation has enjoyed only minimal success in placing any significant limits on telemarketers. For example, consumers can have their names placed on official or semi-official so-called “do-not-call” lists, after which telemarketers are prohibited from soliciting telephone numbers on such lists in the future. However, this requires that consumers must be proactive in requesting that their names be placed on such lists, of which there are many, and in general consumers find it inconvenient to make sure that their names have been added to all of such lists, particularly as the lists are often updated or revised.

Services which allow consumers to screen calls are available over the Public Switched Telephone Network (PSTN) communications system, as are other services or strategies such as having an unlisted number, “call-forwarding”, “three-way calling”, “call-waiting” and “speed-dialing”, as well as paging and mobile telephone systems. However, despite the availability of such further aids and services, users of the PSTN system are limited in their ability both to add and change or vary such calling services, as well as to block and/or screen incoming calls, particularly from individual callers. This is largely because activation or changing of most of these features or services not only involves a fee, but requires the user to first contact the local telephone company and to place a change request. In addition, existing telephone control systems offer very limited control to either the subscriber or the calling party with respect to the processing of calls, and other services cannot be easily integrated with such normal calling functions.

In contrast to the circuit switching technology used in the PSTN network, modern computer networks predominately utilize a packet switching network to exchange data. In packet switching, data to be transferred is broken up into small packets that are individually routed to a destination computer. Each packet contains sufficient identification information to reach its destination, and occupies a transmission line for only tens of milliseconds. Thus, a single document may be divided into several packets, each of which might be transmitted over a different path through the network. Packet switching is much faster than message switching because each packet is forwarded or routed individually without having to wait for the other packets, while in message switching delivery is delayed until an entire block can be delivered at one time. A computer on one end creates the packets, and a computer on the other end re-assembles the packets when received. Other recently developed technologies, such as Asynchronous Transfer Mode (ATM), provide methods for delivering multiple multimedia programs over a single communications channel at speeds of 155 Mbps (million bits per second) via high-speed cables. ATM includes features of both circuit switching and packet switching, and can carry data, voice, video and television signals. In addition, special call processing architectures, including but not limited to, the MCI Intelligent Network, have been developed to provide special calling features and services.

Such advances in microprocessors, networking, and telecommunication technologies have led to the development of large scale public networks, such as the Internet, which is an international network of interconnected networks and computers that allows such computers to interact with each other using a Transmission Control Protocol/Internet Protocol (TCP/IP) or standard wherein each individual computer or network is assigned a unique numerical address and follows a set of rules that permits such computers connected to the Internet to communication with each other. In turn, this has led to the development of packet based telephony (also known as voice over IP, or VOIP, referring to a “variant” of the Transmission Control Protocol (TCP)).

Emergence of packet based telephony has gradually led to the provision of telephone services over public packed data or Internet protocol networks such as the Internet. Numerous Internet Telephone Service Providers (ITSP's) now offer telephony services for connecting calls over the Internet, including the provision of “free” long distance calls. . After verification procedures are completed, the voice call is converted into an Internet Protocol (IP) call and routed over the Internet to the called party, where the IP call is converted back to a voice call. While call quality, and therefore customer satisfaction, of Internet telephony is currently not as high as in the PSTN network, as packets can often be lost during transmission, new technologies are addressing such quality concerns. For example, various technologies have emerged wherein packet based telephony is “fused” with the traditional switch based telephone network, or PSTN. Thus, it is expected that as the quality of Internet telephony services improves, use of Internet telephony will continue to proliferate and expand.

Despite such recent advances in technology, present web-based communications systems, such as web telephony, e-mail, streaming video and the like, presently each or many of such services is activated or controlled via a separate program or interface. This makes it inconvenient and cumbersome for consumers to use and control such features. The present inventor, on the other hand, has discovered that by integrating an Internet communications services control program into a user's Web browser, and by providing each user with a personal telephone home page wherein all of such communications services are easily controlled and varied by the home page owner, a much more user friendly interface and communications experience may result. In essence, the home page owner can use the program and method as a “gatekeeper” which gives such owner full control over his or her communications technologies. For example, one of the key features of the invention is a call-screening feature, which allows only those callers having their calling number or information entered on a list of accepted numbers compiled by the called party to be allowed immediate access to the number. Such call-screening feature can be effectively used to block calls from advertisers, telemarketers, and the like, while being editable or updateable from any computer terminal having access to the Internet. On a larger scale, however, the system can be used to control outside access to other Internet communications technologies, such as e-mail, while at the same time enabling one or more of such technologies to be used together seamlessly from a single control interface.

3. Discussion of Prior Art

As indicated above, the emergence of packet based technology and the Internet has led to an increase in the number of references directed to enhanced calling service systems and features. For example, U.S. Pat. No. 5,745,556 issued to Y. Ronen on Apr. 28, 1998, entitled “INTERACTIVE AND INFORMATION DATA SERVICES TELEPHONE BILLING SYSTEM,” discloses an Internet telephone billing system wherein rather than requiring a user to supply a credit card over the Internet for billing, the user is billed as if he or she had called a 900-number, wherein the charge is added to the user's monthly telephone bill. In one embodiment, an encrypted key known only to the user and telephone company is used to authenticate the billed telephone number.

U.S. Pat. No. 5,958,016 issued to T. Chang et al. on Sep. 28, 1999, entitled “INTERNET-WEB LINK FOR ACCESS TO INTELLIGENT NETWORK SERVICE CONTROL,” discloses a system that allows telephone users to personally access and control their telephone service options via the Internet. While Chang et al. provides a web page type interface for controlling such telephone services, such control is geared mainly to features such as usage reports and billing features, rather than screening calls and the like. Chang et al also does use a “VIP list” such that whenever the service is active, calls originating from stations associated with the telephone numbers on the list pass directly through to the subscriber's station, while numbers not on the list cannot be connected. Such service, however, is offered by the telephone company, and the user must access the telephone company web page and request desired changes be made to the system, rather than making such changes via his or her personal telephone home page. Chang et al. also addresses various security concerns related to the Internet.

U.S. Pat. No. 5,999,525 issued to S. Krishnaswamy on Dec. 7, 1999, entitled “METHOD FOR VIDEO TELEPHONY OVER A HYBRID NETWORK,” discloses a comprehensive system assigned to MCI Communications Corporation for providing various communications services via the Internet. While such patent reads also like a treatise on telephonic communications, and utilizes a personal home page as a message center for meeting scheduling and the like, the home page is not used as a communications feature control center as is the inventor's gatekeeper program.

U.S. Pat. No. 6,028,917 issued to T. E. Creamer et al. on Feb. 22, 2000, entitled “ACCESS TO EXTENDED TELEPHONE SERVICE VIA THE INTERNET,” discloses a system for delivering “extended” telephone services such as caller-id, call waiting, and call forwarding to subscribers outside of the standard PSTN network, such as over the Internet. While such extended services would allow users to screen the importance of waiting telephone calls and convert waiting telephone calls into an e-mail when the computer system is not on, users must “log on” to a telephone company web site to activate and control such features, rather than being able to control such features via a personal telephone home page.

U.S. Pat. No. 6,175,565 issued to P. McKinnon et al on Jan. 16, 2001, entitled “SERIAL TELEPHONE ADAPTER,” discloses a serial telephone adapter which when connected between a serial communications port on a computer and a regular telephone allows a traditional telephone to be used as an Internet telephone for communicating over the computer, rather than using a sound blaster compatible sound card, microtelephone, and speakers of the usual computer. The adapter digitizes one's vocal sounds which are packetized for transfer over the Internet, after which they are received by a second computer, depacketized, and converted back to analog by a similar adapter. When the computer is turned off, the telephone may also be used with the conventional PSTN system. The McKinnon et al. adapter is an example of the types of innovations that may possibly be used with the inventor's control system, in which the adapter would be integrated with other communications features incorporated into a computer terminal.

U.S. Pat. No. 6,185,285 issued to W. E. Relyea et al. on Feb. 6, 2001, entitled “METHOD FOR PROVIDING NETWORK USERS WITH IMPROVED MANAGEMENT OF A COMMUNICATIONS SERVICE FEATURE,” discloses an Internet call management server that can be accessed during a call to activate additional call features, such as three-way conferencing, call waiting, and caller ID blocking. While Relyea illustrates a method for controlling various telephone features using the Internet, in Relyea the Internet is not actually used for telephonic communications and individual user home pages are not utilized to control such features.

U.S. Pat. No. 6,188,683 issued to A. C. Lang et al on Feb. 13, 2001, entitled “SYSTEM AND METHOD FOR ESTABLISHING LONG DISTANCE VOICE COMMUNICATIONS USING THE INTERNET” discloses a system whereby a telephone caller can select a long distance carrier depending upon which long distance provider can connect such call at the least cost. In use, the calling party must first log onto the Internet using the PSTN (public switched telephone network) and browser, wherein he or she accesses a web page. Once the user is identified using a user-id and password, a long distance call request is proffered. The web page computer then analyzes the requested call and selects a carrier for handling the call based on the least cost, and the call is connected, with such call being billed to the caller's previously established account. The inventor descriptively refers to such service as an “Internet Operator service.”

U.S. Pat. No. 6,215,790 issued to E. A. Voit et al on Apr. 10, 2001, entitled “AUTOMATIC CALLED PARTY LOCATOR OVER INTERNET WITH PROVISIONING,” discloses a means for establishing an Internet telephony connection wherein the called party may be contacted at a number of different stations or addresses. Rather than using the conventional PSTN telephone network, the Voit et al. system uses a public packet data network such as the Internet, i.e. Internet telephony. As part of such system, domain names, telephone numbers, or names are translated into IP addresses, such as 610-867-1212@telephone using various translation tables. If the domain name server tries to access a device that is not “live” at the time, the server may choose a second alternative, and so on. While Voit illustrates simultaneous delivery of an Internet call to a domain name and a telephone number domain name, Voit does not illustrate the use of an Internet home page to control access to a personal telephone or communications system.

U.S. Pat. No. 6,226,286 issued to A. O. Danne et al on May 1, 2001, entitled “APPARATUS AND METHOD FOR COMMUNICATIONS BETWEEN DATA NETWORK AND TELECOMMUNICATIONS NETWORK,” discloses a communications node placed between a data network and communications network so that devices such as PC's and conventional telephones can communicate. The service node of the invention is comprised of a web server, personal assistant, and service node selector. Users typically will select communications devices via the web server from an html page in the usual manner. Although Danne et al. broadly discloses a means for controlling various features of telephone communications using a PC, such features are not incorporated into a user's personal telephone home page.

U.S. Pat. No. 6,240,444 issued to T. Fin et al on May 29, 2001, entitled “INTERNET WEB PAGE SHARING,” discloses a system and method for allowing two Internet users to view the same web or HTML page simultaneously, i.e. such that both users see the same page at the same time. In use, two or more users access an HTML web page using a browser such as Netscape or Internet Explorer, so that when the first user sends a browser request, a web sharing manager will automatically send a duplicate message to the second user using a Common Client Interface redirector. A known Web User Interface is then used to create the “look and feel” of the connection and allows tools such as a mouse or pointer to be used. Fin et al. also discloses the use of an annotator, giving the device a handwriting capability so that users can write comments on the web document using a pen device. Fin et al. provides an example of another feature that could be seamlessly controlled by the present inventor's gatekeeper program or communications control system.

U.S. Pat. No. 6,330,317 issued to D. Garfinkel on Dec. 11, 2001 to entitled “CALL BLOCKING SYSTEM,” discloses a system for blocking calls from specific originating numbers to specific destination numbers wherein do-not-call lists are automatically updated so that outgoing telemarketer calls from a company are automatically blocked from connecting with designated numbers on the list. While such system may have some utility in blocking telemarketer calls to some numbers, it does not provide each user with nearly the amount of control over his or her phone or other communications as in the present invention.

U.S. Patent Application Publication No. 20010036253 published on Nov. 1, 2001 entitled “ANSWERING MACHINE HAVING SELECTIVE SCREENING OF INCOMING TELEPHONE CALLS,” discloses a device that is connected between a telephone and PSTN telephone line for screening incoming calls. Incoming calls are matched against a number of codes, wherein if one of the codes matches the call, the phone will ring, but if the call does not match one of the codes, the call will be routed to an answering machine. The Heinzman answering machine is similar in concept to the present invention in that it allows phone calls to be selectively screened, although using the PSTN system rather than the Internet. Heinzman also does not disclose the use of an Internet home page to control such system, and the answering machine therefore cannot be integrated with other communications devices as in the present invention.

### SUMMARY OF THE INVENTION

A personal communication system and particularly a telephone communication system is provided by use of the Internet in which the user establishes an Internet site or home page including control through computer links to such home page of an outside party who can establish direct contact with the user or owner of such personal communication system, including who may leave a message and the like. This is effected by the creation of lists of identification numbers by the user or owner of the site with which communication will be accepted. Since the creation of such lists, including instant deletion from as well as addition to such lists, is completely within the control of the owner or user of the web site, the arrangement or system of the invention enables complete control of contact with outsiders through the web site. In use of the web site as a telephone communication control center the normal telephone number is preferably converted into a domain name and registered in the normal manner or some other domain identity may be established, creating a unique world wide telephone contact point for the personal web site page, or home page, accessible through said domain name, but also completely controlled according to any protocol the web site owner wishes to set up and completely variable instantaneously by the web site owner. The invention can be modified and or supplemented to control various other functions through its Internet connected computer terminal and the personal web page or home page may be used to provide other functions, including answering functions, call waiting, pager service, special call handling options and the like. In accordance with one option the system may be used with a cell phone hookup by which the owner of the cell phone is able to change the lists of the system by operation of the keys of the cell phone either through a personal web site or home page or alternatively an analogous control site provided by a cell phone company.

### BRIEF DESCRIPTION OF THE DRAWINGS

The invention will be explained by way of example only and with reference to the following drawings, wherein:

FIG. 1 is an overall schematic diagram of the network environment of the present system.

FIG. 2 illustrates a typical telephone home page screen display with the gatekeeper program incorporated into the user's web browser program.

FIG. 3 illustrates an example of a personal calling or screening list used with the present invention.

FIG. 4 is a flowchart illustrating the principal steps involved in making a web telephone call using the gatekeeper program.

FIG. 4a is a slightly more comprehensive flowchart illustrating the steps described in FIG. 4.

FIG. 5 illustrates a screen display when a telephone home page cannot be found.

FIG. 6 illustrates a screen display prompting a caller to enter his or her caller identification number.

FIG. 7 illustrates an example of an HTML code for restricting access to a caller's web phone number.

FIG. 8 illustrates a wav file phone message left using the gatekeeper system.

FIG. 9 illustrates a typical e-mail message left using the gatekeeper system.

FIG. 10 illustrates attachment of a facsimile forwarded as an e-mail attachment using the gatekeeper system.

FIG. 11 is a flowchart illustrating the steps in connecting a web phone call using the gatekeeper system in an emergency situation.

FIG. 12 is an example of an emergency access code sent to a caller's e-mail address using the gatekeeper system.

FIG. 13 illustrates a screen display as seen by a caller using the gatekeeper system during an emergency call.

FIG. 14 illustrates a typical screen display when using the chat feature with the gatekeeper system.

FIG. 15 is a flowchart illustrating the steps in sending an attachment file between calling party's using the gatekeeper system.

FIG. 16 illustrates a screen display in sending an attachment file to a party using the gatekeeper system.

FIG. 17 illustrates a schematic diagram of an alternative embodiment of the invention used as an added subscriber service used in connection with a cellular telephone service.

FIG. 18 is a flowchart illustrating use of the gatekeeper program as an added service to a cell phone service as shown in FIG. 17.

### DETAILED DESCRIPTION OF THE INVENTION

The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

In the following exemplary non-limiting embodiment of the invention, the invention is shown and described as it might be utilized by a residence, family or individual user. However, it is understood that the invention could be easily adapted for use by a business or other organization, and generally may be used in a similar manner.

The present invention is directed to, among other things, a system and method for controlling outside access or connection to one's telephone number or address, so that only certain designated calling parties can access such number or address, while telemarketers or other unknown or unwanted callers are screened out and prevented from accessing the number. While it is known in a regular PSTN network that a user can contact the telecommunications provider, typically a telephone company, and request that the number be unlisted or that calls from certain number be blocked, the present system provides the user with a much greater ability to control his telephone connection and features, as well as other communications features such as e-mail, cell phone, answering machine and the like, as will be explained below.

The invention comprises, therefor, a personal communications system or method, or “gatekeeper,” wherein users are able to control not only the ability of outside caller's to connect to an Internet telephone number or domain name address, thereby preventing unwanted telephone calls from telemarketers, advertisers and the like from being connected, but also enabling users to control numerous other communications devices including, but not limited to, e-mail, facsimile, pager, cell phone, and streaming video. In one mode, the present system relies on the use of a computer terminal connected to the Internet and an Internet home page, wherein incoming Internet telephone calls will be routed to the computer, with the ability of the caller to establish a connection with such telephone number controlled by the user. Each user will create a personal web page or home page, typically through an ISP (Internet Service Provider), and preferably having a domain name which corresponds to a regular telephone number. For example, if such persons regular phone number is (444) 555-1000, the domain name preferably will be similar, such as “wwww.444-555-1000.com,” although any suitable domain name can be used. The program is also preferably incorporated as a plug-in to the user's Internet web browser program.

The owner of the home page is able to control access to his or her Internet telephone number, and therefore any associated communications features, by compiling lists holding identification information or other code capable of discerning the identity of individual callers. Such lists are preferably stored on the disk space provided by the users ISP. Typically, the identity information may include the personal telephone by number of a family member, friend, business associate, or any other person or number corresponding to individuals from whom it is desired to receive calls or other types of communications. Thus, anyone whose identification information is on a list will be able to contact the home page owner via the communications means which are associated with such list, while others such as telemarketers whose identity information is not contained on the list will be blocked from establishing a direct connection, although at the option of the home page owner the caller may be allowed to leave a recorded message or to establish some other option or contact rather than being merely disconnected with or without an explanation. Numerous other calling features, such as providing distinctive rings to alert individual family or group members sharing a number or address to an incoming call, may also be provided. Thus, the system acts as a gatekeeper between the called party and all outside callers.

As indicated above, the gatekeeper program also incorporates or can be used to control an answering machine feature, wherein callers having identification information placed on an answering machine screening list can leave a message, which message is preferably attached to the owner's e-mail as a wav.file. A temporary code will preferably be added to the e-mail address, so that telemarketers or spammers cannot continually leave post advertising e-mails through the telephone system. Also controllable by the gatekeeper program are a pager function, call forwarding, cell phone, a conference or chat feature, an electronic attachments feature, streaming video, call recording, and a note pad feature. While normally a caller without any identifying information on a screening list will be denied access to the related communications feature, a provision for emergency access wherein when an emergency access code enabling a caller to bypass the screening lists is provided, which code is only good for a few hours. A screen capture feature, which allows a secondary screen to be opened so that the caller and recipient can discuss a drawing or the like and wherein each can point to various portions of the drawing using their mouse, can also be controlled by the system.

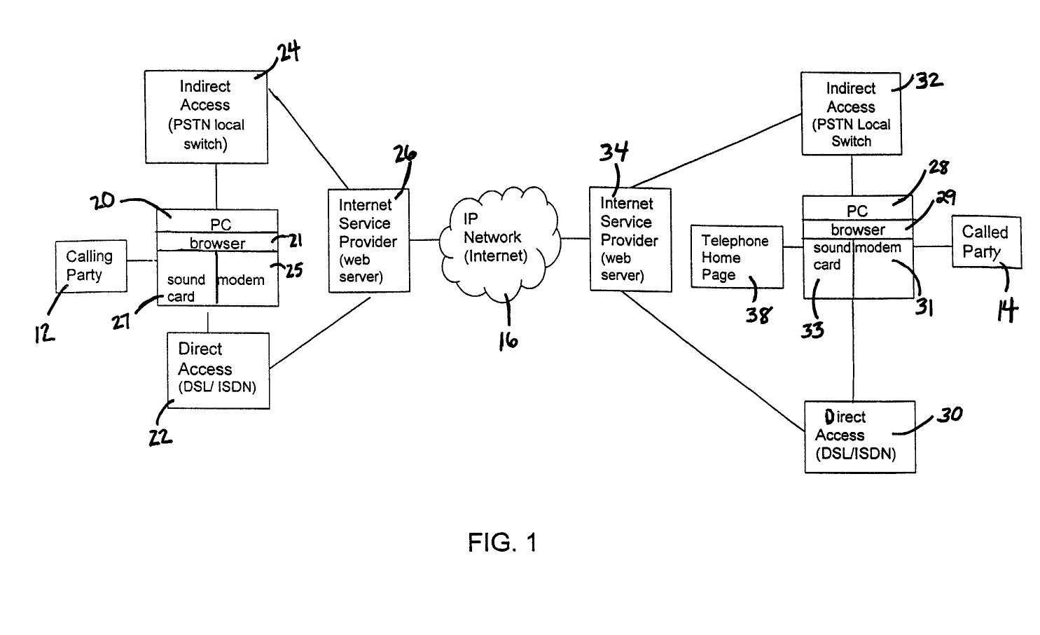

FIG. 1 is a block schematic diagram of an arrangement in accordance with the invention for routing a call, such as a voice call, from an outside or calling party 12 to a called party 14 over an IP network 16. While in the present example such network is illustrated as being the public Internet 16, it will be understood by those skilled in the art that such network may also be one or more private intranets or private networks within one or more organizations. Typically, a calling party 12 will access the World Wide Web portion of the Internet via a personal computer (PC) 20 having a web browser program 21 or application stored on a disk drive. Browser program 21 may be one of several browsers commonly known in the art, including but not limited to Microsoft Internet Explorer®, Netscape Navigator®, Spyglass Mosaic, or other browser program capable of processing information from a Web site and displaying such information. The calling party 12 will typically access the Internet via either direct network access 22, including but not limited to Integrated Data Service Network (ISDN), Digital Subscriber Line (DSL), cable modem services, or indirectly 24 through the Public Switched Telephone Network (PSTN) using a dial-up modem 25. Telephony servers may be coupled to both the data network as well as to the PSTN. In addition, as explained below, the called party 14 will also create a personal telephone home page 38 using the gatekeeper program of the present invention.

Computer 20 will typically be comprised of a standard computer keyboard, a mouse, and a CRT or LCD monitor, each connected to the computer as is known in the art. Computer 20 may also be equipped with auxiliary components such as a printer and scanner, and in addition will include a means for communicating sounds, video, and the like. Today, most personal computers include a sound card 27, such as Creative Labs SB4740 Sound Blaster 16 PCI, to which a microtelephone and speakers, not shown, are attached so that sounds, video and the like can be communicated through the computer via the sound card 27. However, other communications devices, such as a packet based telephone, may be substituted. An Internet Service Provider (ISP) 26 or other commercial entity that charges a monthly fee in exchange for providing subscribers with access to the Internet may usually be used to access content on the Internet, so that the ISP web server receives HTTP requests from the web browser and provides HTML web pages in response. Called party 14 will also typically connect to the Internet in a similar manner via his or her own personal computer 28 having a browser program 29, modem 31, and sound card 33, either via direct networking access 30 or standard PSTN access 32, usually through an ISP 34.

While in FIG. 1 a personal computer (PC) is used to access the Internet, it is to be understood that a broad range of other terminals or network appliances having the necessary software and known in the prior art may be substituted. Examples of suitable appliances include, but are not limited to, Thinkpad laptop and notebook computers available from IBM, Inc., Dimension desktop computers available from Dell Computer of Austin, Tex., iMac available from Apple Computers of Cupertino, Calif., and hand held computing devices such as a Palm Pilot® available from 3COM Corporation of San Jose, Calif. In addition, wireless and packet based telephones or similar devices capable of accessing the Internet and having a screen display and other features may also be suitable.

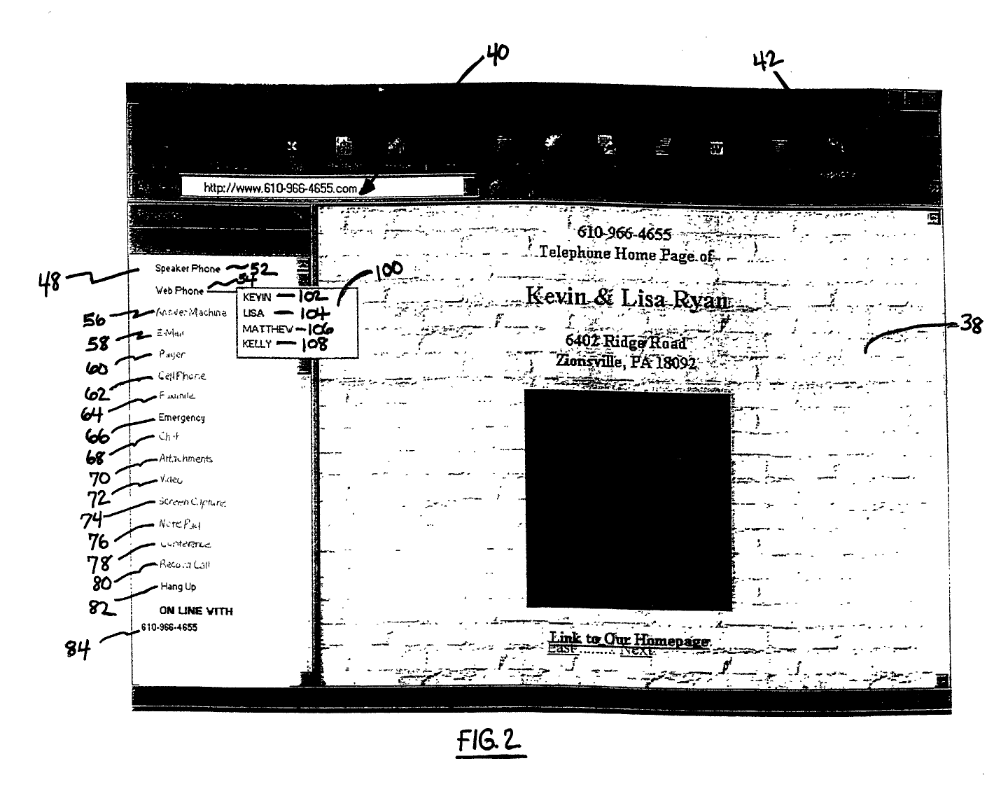

In accord with the invention, prior to using the inventors gatekeeper system, each user will create an communications control interface or home page, such as home page 38 shown in FIG. 2. Home page 38 is capable of being displayed on the World Wide Web using a suitable hypertext formatting language such as hypertext markup language (HTML), and serves as the primary interface for using the inventors communications control system. Each user home page 38 will have a unique alphanumeric Internet address and at least one domain name 40 which uniquely identifies the location of such home page. In practice, the domain name 40 will be used in essentially the same manner as a telephone number is used in the regular PSTN system, so that a calling party can place a call over the Internet or other packed data network simply by entering such person's telephone home page address. Preferably, each home page address 40 will correspond as closely as possible to the user's existing PSTN telephone number. For example, if a user's main telephone number is (999) 966-4655, a preferred communications control home page domain name address might be www.999-966-4655.com. However, it is understood that any domain name address pointing to the home page may be used with the invention, although preferably such address should be capable of descriptively identifying the individual or organization in some manner. The domain name address could also be used to point Internet calling requests to the location of the party receiving the call. Alternately, this information could be placed on the homepage or provided by the ISP to Internet browsers accessing that particular telephone homepage.

Telephone home page 38 can be set up organized in various suitable ways, such as a stand-alone web page, as a portion of a primary home page, or as a secondary page linked to a primary home page. For example, currently many Internet Service Providers (ISP's) offer subscribers at least 10 megabytes of free space on their web servers with which such subscribers can create and maintain their own personal Web site. A personal Web site typically includes a collection of web pages in HTML format, with each page containing various content, such as text, graphics, or other multimedia material, as well as links to other site and various buttons. Creating a web site typically requires generating a plurality of pages using HTML, as does adding content to the site once the web site itself has been created. A portion of such allotted server space, for example requiring approximately 2 megabytes out of the total provided by the ISP, may be partitioned from the personal home page for use as a control home page 38.

In FIG. 2, a telephone icon or button 42 is shown integrated into the Standard Buttons toolbar 44 on the Microsoft Internet Explorer® browser. When telephone icon or button 42 is pressed, graphical options menu 48 is activated and appears on the screen. The telephone button 42 will be activated only when the called party, corresponding to domain address 40, has installed the inventor's gatekeeper program or a compatible program. Alternatively, the link to options menu 48 can also be provided from one or more other standard toolbars, or even from a separate dedicated toolbar. Preferably, the gatekeeper program will be provided either as part of a browser program or as a plug-in to such browser program, although such program is equally effective if provided separately and either incorporated into the browser program, or if used alone. As a further example, a shortcut to the home page 38 might be provided from the desktop of the Microsoft Windows operating system by creating a desktop icon pointing directly to such home page. Home page 38 may contain any information desired by the user, such as a home address, one or more pictures, telephone number, or other contact information links to other web pages, and the like. Of course, as with any Internet home page the overall appearance of such home page can be updated or altered to suit the tastes of individual home page owners using commercially available web page development programs.

As indicated above, when the telephone icon or button 42 is pressed, options menu 48 , shown on the left side of telephone home page 38 in FIG. 2, will appear on the calling party's computer. Options menu 48 is used by outside callers to initiate one or more communications devices belonging to the home page owner, and as will be shown is also used by the home page owner or called party 14 to initiate communications features that can only be initiated by the home page owner. Typical options or features that may appear on the options menu 48, as illustrated in FIG. 2, include, but are not limited to, Speaker Telephone 52, Web Telephone 54, Answer Machine 56, E-mail 58, Pager 60, Cell Telephone 62, Facsimile 64, Emergency 66, Chat 68, Attachments 70, Video 72, Screen Capture 74, Note Pad 76, Conference 78, Record Call 80, and Hang Up 82. When one of such buttons is pressed when activated as described below, the corresponding feature or routines is initiated, also as described below.

The telephone number of the called party 14 is displayed both as a domain name address 40 and on options menu 48 at number 84. As indicated above, each of the options listed in the options menu 48 may be individually activated or disabled. Options shown in bold print on options menu 48 in FIG. 2 are active so that the corresponding communications devices can be initiated by outside caller 12, while options in lighter print are disabled so that outside caller 12 cannot click on or activate the corresponding communications devices. In the example shown in FIG. 2, only the Speaker Telephone 52, Web Telephone 54, Emergency 66, and Hang Up 82 options are currently active. As illustrated below, the present communications control system allows a user to separately designate each of such options as being active or disabled for each individual caller or calling number. Thus, while a first caller may be able to either call or send an e-mail to the home page owner 14, wherein the Web Telephone 54 and E-mail 58 options are activated, a second caller may only be able to leave a message using the Answer Machine 56 option or button, with the Web Telephone 54 and E-mail 58 options being disabled. Thus, options menu 48 of home page 38 acts as a “gatekeeper” between the user and all outside parties trying to connect to such number regardless of the method of communication requested so that the called party or home page owner is able to control not only who may establish a connection, but also which options will be available to the caller. (The term “caller” is used from time to time throughout the specification to refer to any outside party trying to establish a connection with a particular telephone number or address, and may include not only audible or verbal communications, but any and all of the methods of communication possibly available on the options menu 48.)

One mode for enabling a user of the present system to designate which communications features will be made available to individual callers is through the compilation of one or more lists containing information capable of identifying such callers, wherein each list corresponds to one or more of the communications options available on the options menu 48. In general, if a caller is identified on a list, the option is activated, while if such caller is not identified on the list, the option remains inactive or is disabled. The opposite arrangement could also be used, i.e., wherein all of the options remain active to a caller unless such caller is identified on one of the lists, with the result that the corresponding option is disabled. However, it is believed that the first arrangement results in a much more useful caller screening tool than would otherwise result.

A relatively simple and therefore preferred method of identifying callers is by their telephone numbers or personal telephone home page addresses. Each telephone home page owner would compile a list or lists of numbers or addresses of those persons, families, organizations and the like which the user wishes to be able to access the number using at least one of the listed options or features. Separate lists may be compiled for each of the different options on the options menu 48 or, alternatively, the owner may be able to input each telephone number or domain name address into a single page or screen and then designate on a checklist or the like on which option's lists such number will appear. A default setting may also be used wherein such default could be modified when desired.

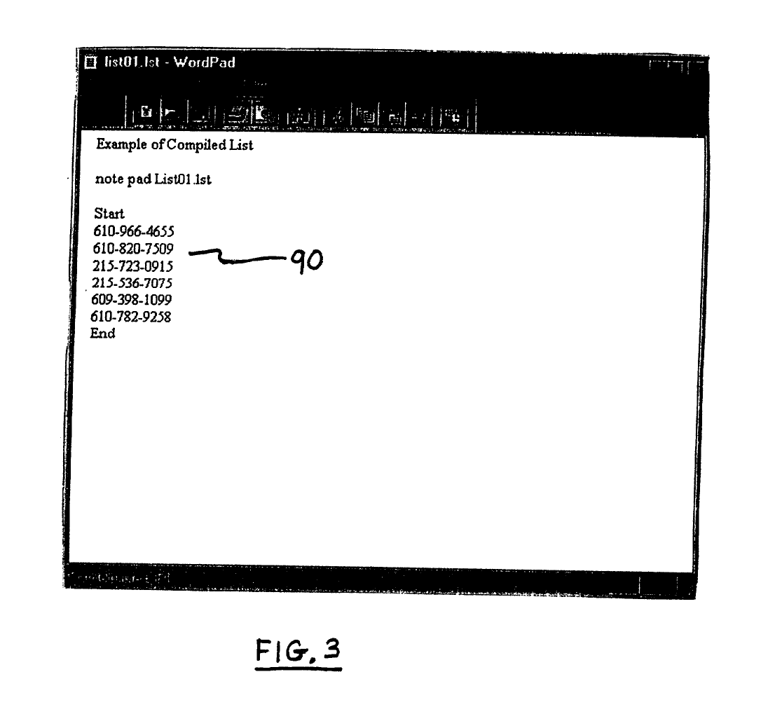

As a non-limiting example, FIG. 3 illustrates a list 90 of telephone numbers generated using the Wordpad feature of Microsoft Windows installed in a PC. As shown in FIG. 3, the telephone numbers are simply typed or input into the computer, wherein they are saved and compiled by a compiler program into object code for use by the computer. Once compiled, the lists are preferably saved as a separate file on the server space provided by the user's ISP, which file is scrambled so that outside persons cannot read the files without considerable difficulty. Each time a change is made to the list, the list must be recompiled and saved to the ISP held homepage. The gatekeeper program, when prompted, will retrieve and read the compiled lists to determine if caller identification information is on the list.

The number of addresses on each list will obviously vary depending upon which options or features the user wishes to be activated for each individual caller. For example, some home page owners might wish a larger number of callers to be able to leave an answering machine message via voice or written e-mail, while fewer callers would have access to actually ringing the web telephone. Such lists may also be created or amended via a separate computer, personal digital assistant (PDA), or other Internet ready appliance and uploaded via a cable, infrared, or wireless connection, or by other suitable means.

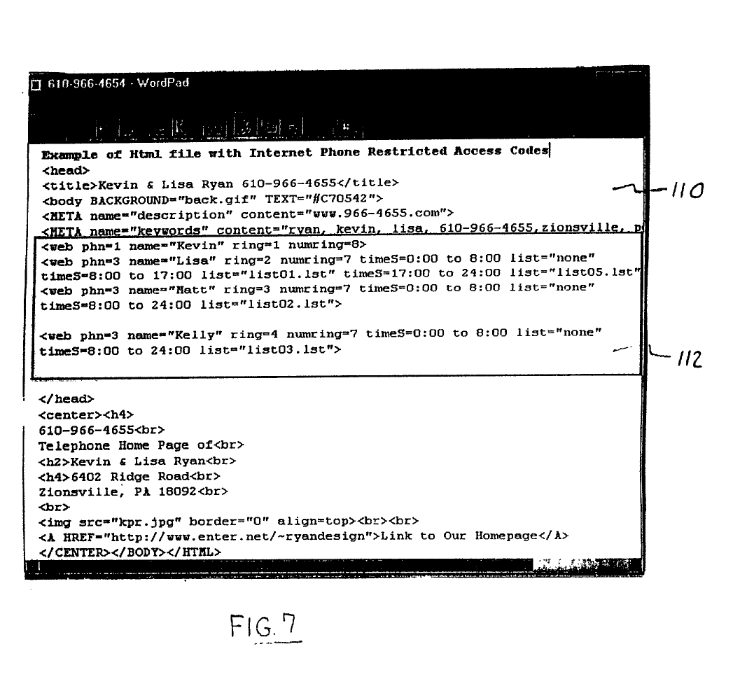

In a slightly less preferred embodiment, the user may configure the system to accept certain calls on a need basis. For example, a telephone home page owner may place a call to a friend or business associate who is not immediately available and who plans to return the call shortly. Since the user wishes such person to be able to connect the return call, such number may be, at least for a short period of time, added to the list of desired caller numbers. One possible method of quickly adding such number to a list may be by making available a button or icon on the computer screen which can be pressed during or after the call to automatically add such number to one or more lists, wherein the number may then be stored in memory permanently or temporarily. If temporarily, the user preferably may specify the length of time such number is to be included on such list or lists. In other words, the lists should be easily updated, although each time a number is added the lists will still have to be recompiled and downloaded to the ISP. In addition, as indicated above, while it is preferred that callers be identified by their telephone number or home page address, such lists could also be comprised of other information capable of identifying a caller, such as by name, nickname, or the like. Another possible option shown below is for the calling lists to be operational only at certain times of the day, such as around dinnertime or late at night when it might be much less desirable to receive a call from other than a few select persons. Yet another option would be to have different lists activated at different times of the day. As described with reference to FIG. 7 below, to prevent caller's from bypassing the gatekeeper system, the current time is determined by downloading the time from the receiving party's ISP.

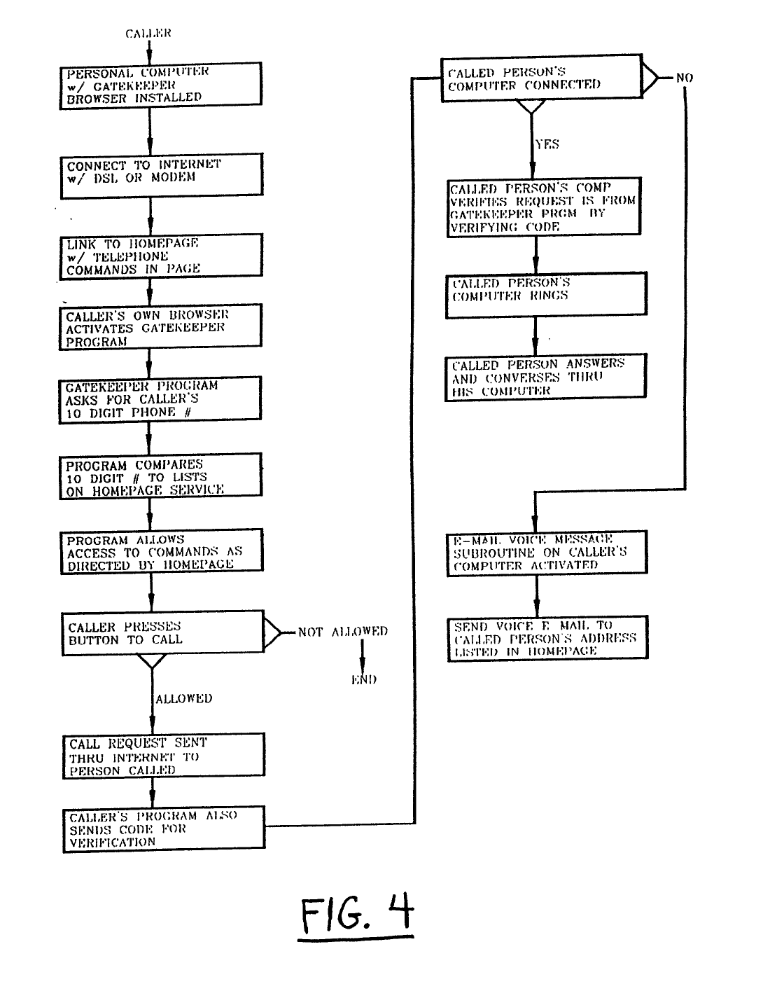

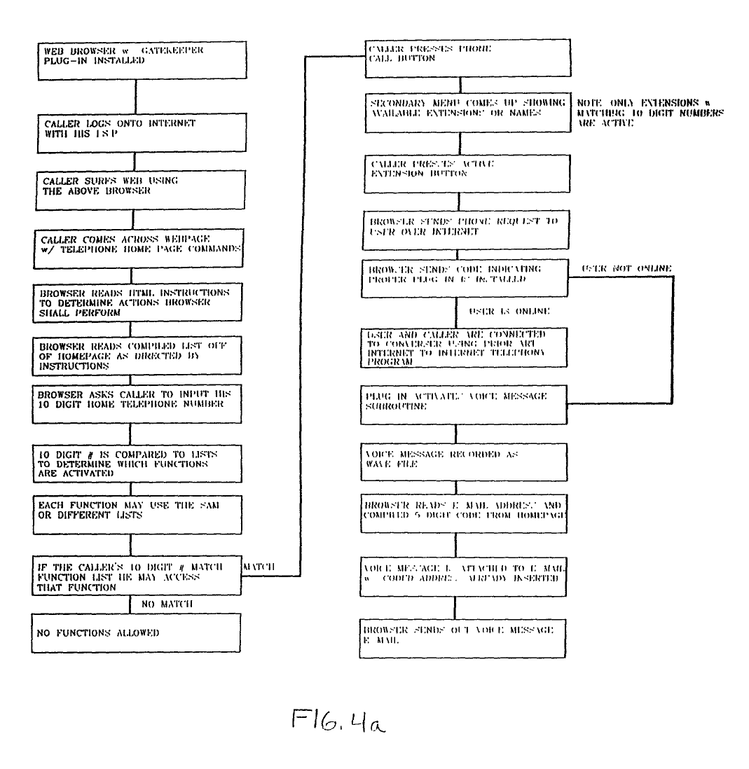

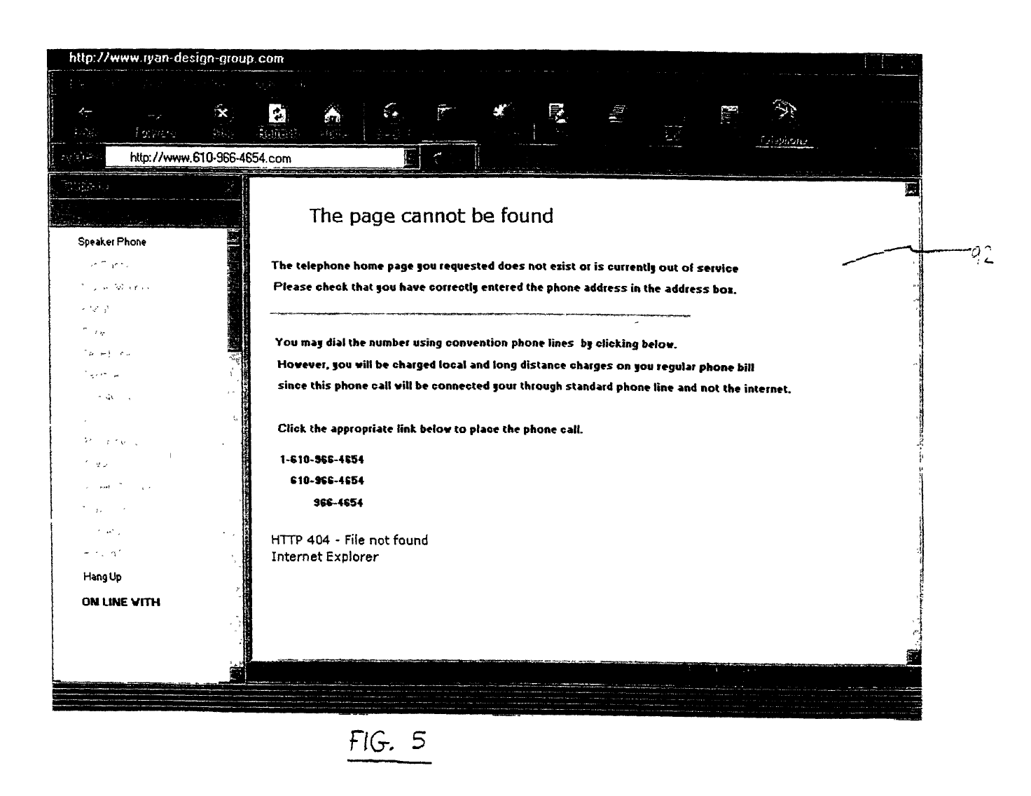

The steps in making a call using the present invention in the network environment illustrated in FIG. 1 are outlined in the flowchart of FIG. 4, and in slightly more detail in FIG. 4a. First, the gatekeeper program must be installed in the program memory of the caller's computer 20, preferably as a plug-in to such persons web browser program. After the gatekeeper program has been installed on the caller's computer, the caller will connect to the Internet either directly via DSL, ISDN service or other direct line or indirectly via a dial-up modem via his or her Internet Service Provider (ISP). It is understood that the user can connect to the Internet from any suitable computer or other device capable of accessing the World Wide Web. Once an Internet connection has been established and the caller's designated browser home page appears on the screen, the caller either will “surf” the Internet and locate a webpage having the telephone home page commands, or will simply input an Internet telephone number or home page domain name address of a party he or she wishes to contact using the telephone commands in the gatekeeper program. If the called party does not have a telephone home page, a standard browser screen and message 92 similar to the one shown in FIG. 5 will be displayed, indicating that the call cannot be connected, and that the caller may alternatively try to connect the call via the regular PSTN system using the computer speaker-telephone or telephone. If the caller has a single telephone line, the browser program 29 will be disconnected from such telephone line so that the PSTN call can be made. Of course, disconnection may not be necessary if the caller has a DSL, cable, or other broadband Internet connection. After the call is completed, the computer may then automatically reestablish an Internet connection.

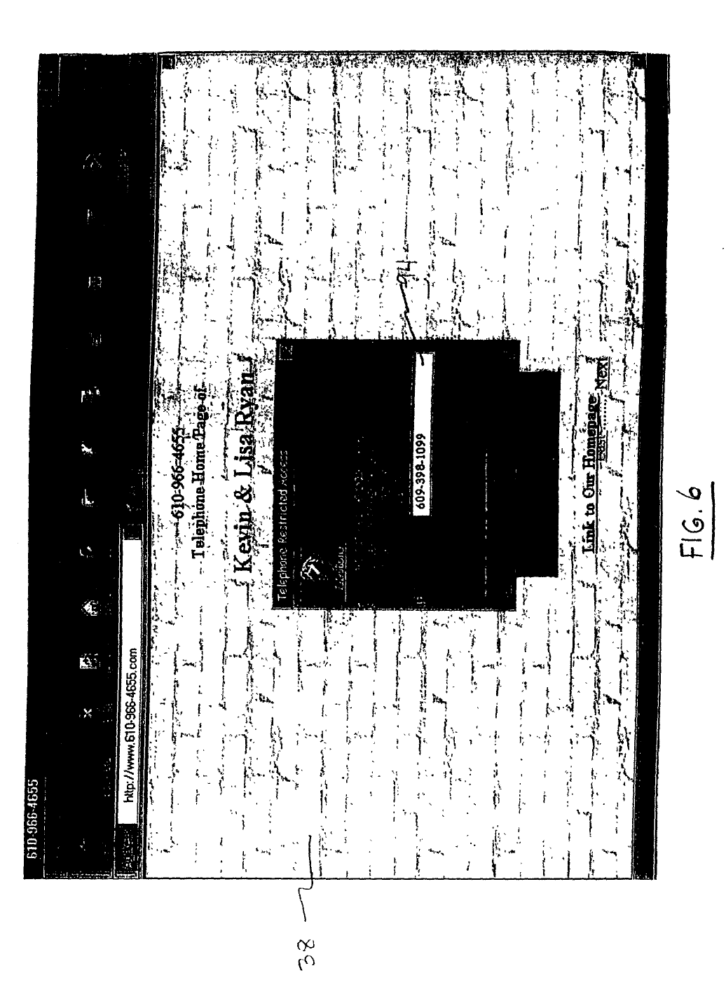

If the called party 14 has created a home page 38 having the gatekeeper program installed, as shown in FIG. 4a, the caller's browser will then read the HTML instructions from the home page, and at the same time will read the compiled lists of identification numbers from such home page. A screen will then appear similar to the one shown in FIG. 6 wherein superimposed over home page 38 is a box 94 prompting caller 12 to enter his or her ten digit home telephone number. Box 94 will preferably appear any time a call is made to a telephone number or address having one or more restricted access commands of the gatekeeper program activated.

After the caller enters his or her ten digit home telephone number in box 94 and sends it to the browser by clicking on the enter command 95, the gatekeeper program will then compare such number with the numbers on the compiled screening lists to determine which communications functions are activated. As indicated above, the caller's number may appear on one, several, or none of the lists corresponding to each of such communications functions. For example, the number may appear on the list controlling access to Web Telephone 54, but not on the list controlling access to Answering Machine 56. In such instance, caller 12 will be able to connect to the called party via an Internet Telephone call, but will not be able to leave an answering machine message unless the call is not answered. Each function may be associated with the same list, or different lists can be associated with different functions. In either event, each communications function associated with a list on which the caller's number has been placed by the called party 14 will be active, and can be used to access such party by the caller 12. See again FIG. 2, wherein the functions in bold print are activated, while the functions in light print remain inactive, although other means for indicating active or inactive functions can be used, such as different colors or the like. In this manner, the called party's gatekeeper program will dictate whether or not, or using which functions, caller 12 will be able to contact or connect with the called party's telephone number or address. Of course, if all of the access lists of the gatekeeper program are temporarily disabled, the caller 12 will have access to all of the features of the system. This may be the case, for example, if the gatekeeper program is used in a business environment, wherein it is desired to receive orders or incoming calls from virtually all outside callers. On the other hand, if the gatekeeper program is activated and the caller's number is not on any of the lists, none of the features on the options menu 48 will be active, with the exception of the Speaker Telephone 52, Emergency 66, and Hang Up 82 features. In such case, as explained below, the caller 12 will only be able to connect to such called party's telephone line via a regular, non-Internet telephone connection or in an emergency situation using the Emergency 66 feature.

If the number or address input by the caller 12 in box 94 matches a number on one or more of the screening lists, the communications functions associated with such list or lists will be activated. Caller 12 will next press on the telephone phone call button 42, wherein, as shown in FIG. 2, options menu 48 will appear preferably adjacent to home page 38. Caller 12 can now place a call or communications request by clicking on any of the active communications options, such as the Web Telephone option 54. Such request will be sent over the Internet by the browser to the called party's computer in a manner known to those skilled in the art. Accompanying such call request is a code used to verify that the caller 12 has installed a program or plug-in that is the same as or at least compatible with the gatekeeper program 10. If the called party's computer is turned on and connected to the Internet when the call request is transmitted, prior to screen 38 with box 94 superimposed thereon as shown in FIG. 6 appearing, the called party's computer will first analyze the verification code to verify that the call request is from a terminal having such a compatible program installed. If the caller does not have a compatible program or plug-in installed, the call will be disconnected. On the other hand, if the call is from a computer having a compatible program or plug-in, and the called party is connected to the Internet at the time of the call, the called party's computer or attached web telephone will ring. If the called party 14 answers the call, the call will be connected using a prior art Internet to Internet telephony program of a type known to those skilled in the art, and the two party's can converse via such Internet telephone connection in the normal manner. Conversely, if the called party is not online or connected to the Internet when the call is received, the program or plug-in will preferably activate a voice message subroutine on the caller's computer. As shown in FIG. 4a, the voice message will preferably be recorded as a wav. file and saved as a voice message e-mail. In addition, as explained in detail below, a security code will preferably be read and added to each e-mail address prior to delivery of the e-mail. Such security code is designed to prevent advertisers from sending unsolicited e-mails to the user.

FIG. 2 also illustrates one way in which the present system can be used or shared by more than called party. In FIG. 2, home page 38 and domain name address 40 are shared by four separate users. Such persons may share either the same host computer or Internet terminal, or alternatively one or more of such users may have separate personal computers connected via a Local Area Network (LAN). After the caller's telephone number has been entered as shown in FIG. 6, the gatekeeper program will determine if such number has been placed on one of the screening lists. In the example shown in FIG. 2, the Speaker Telephone 52, Web Telephone 54, and Emergency 66 features are active. When the caller 12 clicks on the Web Telephone 54 button, a submenu 100, wherein, for purposes of illustration only, the names of four family members Kevin 102, Lisa 104, Matthew 106, and Kelly 108 appear. In the present example, Kevin and Lisa's names 102 and 104 are activated, while Matthew and Kelly's names 106 and 108 are not, indicating that the caller's telephone number has been entered on Kevin and Lisa's currently active screening lists, but not on Matthew or Kelly's. Caller 12 can now click on either Kevin 102 or Lisa's 104 name, wherein such call will be routed to either Kevin or Lisa's computer, and a ringer or other signal or indication for an incoming call will be activated. As indicated above, each user's telephone may activate a different ringer so that the family members will immediately know whom the incoming call is for. To answer the call, the called party will simply click on his or her Internet browser 29, which will preferably appear automatically on the screen whenever the number is called. The caller's voice will then be audible through the computer speakers, while the called party's voice will transmit to the caller through a microtelephone.

FIG. 7 illustrates in the boxed area 112 of the screen 110 an example of how the screening lists can be programmed to further restricted access to certain called parties by programming access codes into an HTML file of the gatekeeper program. As shown in box 112, line 1, no restrictions have been placed on called party Kevin 102. Therefore, as shown in FIG. 2, Kevin 102 is free to receive calls from any outside party. Alternatively, the gatekeeper system can also be programmed so that if no caller information is included for Kevin 102, Kevin will not be able to receive calls from any outside callers, and therefore Kevin's name would not be listed. Called party Lisa 104 has several additional restrictions, shown in lines 2 and 3 of box 112. Such restrictions are divided into three time periods, shown in military time, so that from 12:00 to 8:00 a.m., no lists are activated, with the result that Lisa cannot receive any calls during such time period. From 8:00 a.m. to 17:00 or 5:00 p.m., list 1 is activated, so that anyone calling Lisa between 8:00 a.m. and 5:00 p.m. having his or her name on list 1 can ring Lisa's telephone. From 5:00 p.m. to 24:00 or midnight, list 5 rather than list 1 is activated, so that only caller's on list 5 during such time period can ring Lisa's telephone. Similarly, called party Matt 106 has no lists activated between 12:00 a.m. and 8:00 a.m., while list 2 is activated between 8:00 a.m. and midnight; Kelly 108 also has no lists activated between 12:00 a.m. and 8:00 a.m., but list 3 is activated between 8:00 a.m. and midnight. Note also that each called party has a different ring programmed or associated with his or her number.

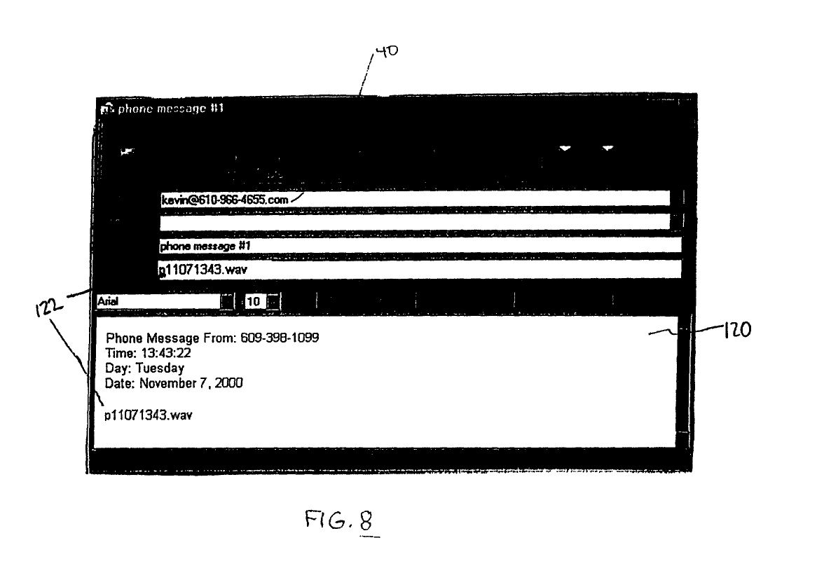

The Answering Machine button 56 operates in generally the same manner as the Web Telephone button 54, whereby the ability of an outside caller 12 to access the called party's answering machine is dependent upon whether or not the caller's number 30 has been placed on the screening list currently controlling access to such communications option. In addition, different answering machines can be designated for each party using the telephone home page or address. FIG. 8 illustrates a typical email message or screen 120 to be sent to the called party's e-mail address 40 having a voice message 122 included as a file attachment in a manner well known in the art. Voice message 122 is preferably recorded in waveform audio, or wav, file format, although any suitable format may be used. The allowable length of voice message 122 preferably can be controlled or set by the called party 14. As explained below, such voice message will preferably have a security code added to the address to prevent unwanted e-mails.

As indicated above, in addition to controlling access to one's telephone number and corresponding communications features, the present invention can also be used to control access to one's e-mail address. Just as telemarketers make cold calls to a user's telephone number, it is well known that advertisers continually send unsolicited, or “junk,” commercial e-mails to numerous e-mail addresses and newsgroups. While online advertising is generally accepted on the Internet, and several ISP's have implemented filters to reject e-mail messages from addresses of known “spammers,” the present system, by allowing an e-mail recipient to receive e-mails only from other email addresses which have been previously placed on a screening list, provides users with significant additional protection from spammers. The screening feature also acts as a safety feature, since Internet viruses, which are essentially programs that attach to and infect computer operating systems and other computer files, are often passed via random or deceptive e-mail messages. Using the present system, such e-mails would not be accepted since the spamming party has no way of knowing what names have been placed on such persons e-mail screening list.

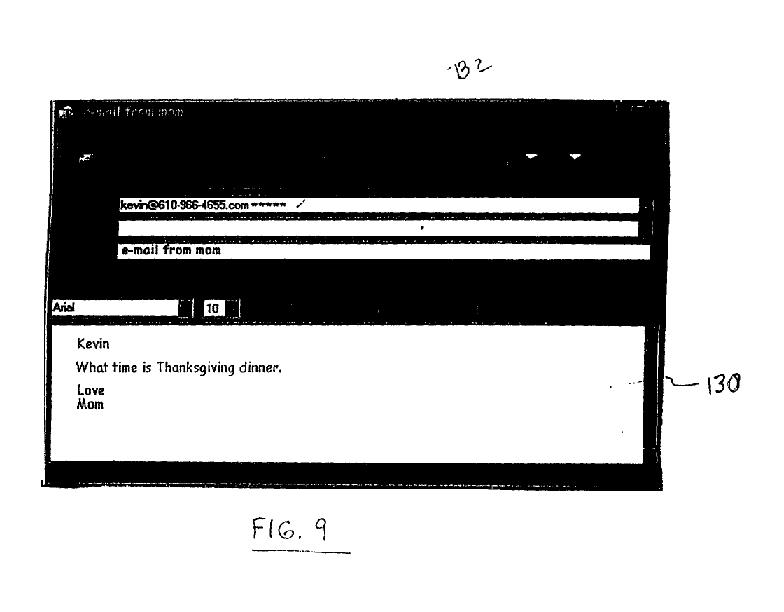

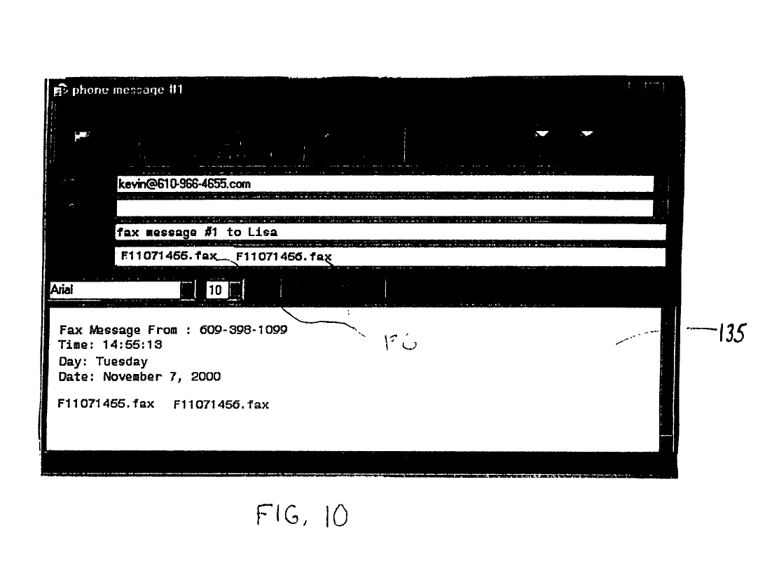

To help ensure that the user's e-mail address is kept private, each time the Email button 58 shown in FIG. 2 is pressed by a calling party, a five-digit code is preferably added to the end of such user's e-mail address. The code is preferably stored in a compiled file at the user's ISP web server. An example of an e-mail address having the code attached is as follows: kevin@610-966-4655.com57632. However, to the outside caller or party, the e-mail address will appear as kevin@610-966-4655.com*****, also identified as number 132 on e-mail screen 130 in FIG. 9, so that the calling or e-mailing party cannot see the five digit code. In addition, the code will be changed periodically, such as once a week, so that spammers who might be tempted to break the code one week cannot continually bombard the site with e-mails or sell the email address to third parties, since as soon as the code is changed, the e-mail will be rejected. Thus, not only is the e-mail feature 56 of the gatekeeper program 10 protected by the screening lists, but also the changeable five-digit code. Such code will also preferably be used with all other communications functions, including facsimile and voicemail communications, as shown in FIGS. 8 and 10. The Internet Service Provider's mail router service also must be reprogrammed so that, prior to forwarding an e-mail, it will read the five digit code, wherein if the proper code has been used, the e-mail will be routed to the correct recipient, but if an expired or incorrect code is used, the mail will not be forwarded.

The Pager 60 and Cell Telephone 62 commands illustrated in FIG. 2 are generally used in the same manner as the Web Telephone 54 command. First, the home page owner will compile lists of numbers or addresses of callers who are allowed to connect to or access such communications features. Assuming the called party is online, and the gatekeeper program has verified the identify of a caller 12 and activated the Pager command 60, when caller 12 clicks on Pager command 60, he or she will be prompted to input an alphanumeric string or sequence in the usual manner, forming a short message. The called party's Internet browser will then dial such party's pager number and forward the message to the pager. If the called party only has one telephone line, the computer would first have to disconnect from the Internet so that the pager number can be dialed using the same line. After the pager number has been dialed and the message forwarded, the computer preferably is then reconnected to the Internet.

Cell telephone command 62 would also operate generally in the same manner as the other features. However, use of the Cell telephone screening feature 62 requires that the user have either a broadband Internet connection or at least two telephone lines, since the call would have to be forwarded via a separation connection from the called party's computer to the cellular telephone while the calling party remains connected on the first line to such computer. In addition, the user would require an Internet ready cellular telephone, such as the T250 model manufactured by Mitsubishi Electric Mobile Communications USA. One advantage of controlling access to the called party's cellular telephone using the telephone home page gatekeeper concept is that expensive air or calling time minutes can be more easily controlled. For example, rather than allowing calls to be directly connected to the cellular telephone, the home page could be configured to first send a pager message to the cell telephone. The called party could then review such pager message at his or her relative leisure and make a determination whether or not to place a return call to such party. HTML commands readable only by Internet ready telephones could be added to the end of the telephone home page 40, so that the telephone home page supports not only traditional Internet computer access browsing but also Internet cellular telephone access browsing. As indicated previously, this would allow the screening lists to be updated or amended from the cell telephone, so that the user could add numbers from the field or away from home instead of having to wait until returning home and entering such information directly into the computer. In addition, a series of lists programmed to be alternatively active at different times of the day could also be created or amended, thereby decreasing the likelihood that the lists will become out of date or incomplete.

Facsimile command 64 is controlled in much the same manner as Answering Machine 56, whereby the ability of an outside caller to access the faxing feature is also dependent upon the compiled lists of authorized users. As illustrated in FIG. 10, fax messages will preferably be converted into file e-mail attachments 135 and sent to the called party's e-mail address 136 in a manner well known to those skilled in the art. Each fax may be converted into a separate e-mail attachment if desired. In addition, similar to the Web Phone 54 and Answer Machine 56 functions, faxes can be directed to a particular user or network of computers sharing the same telephone home page interface. Such feature also may be arranged so that faxes can be directed to a particular party, and while some individuals may receive a fax message, others may not. As described above, a security code will also preferably be added to the end of the e-mail address of the e-mail having the facsimile attached.

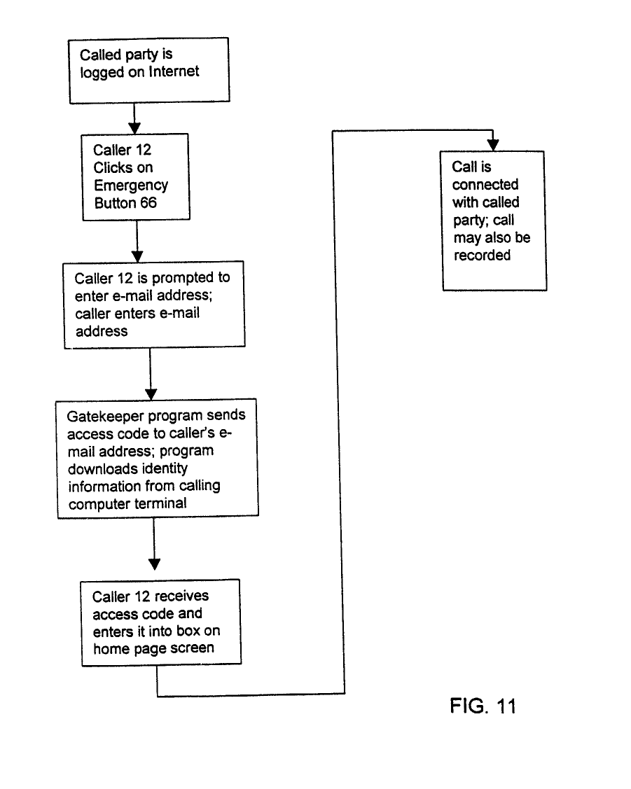

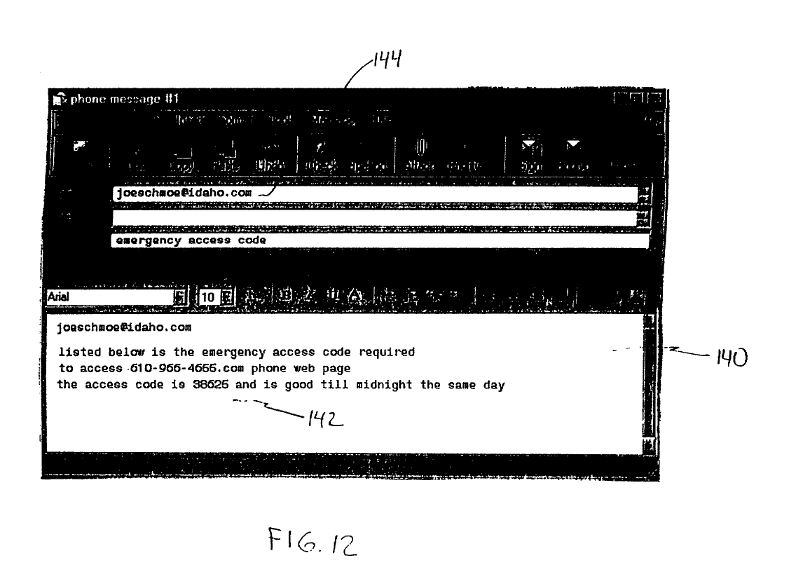

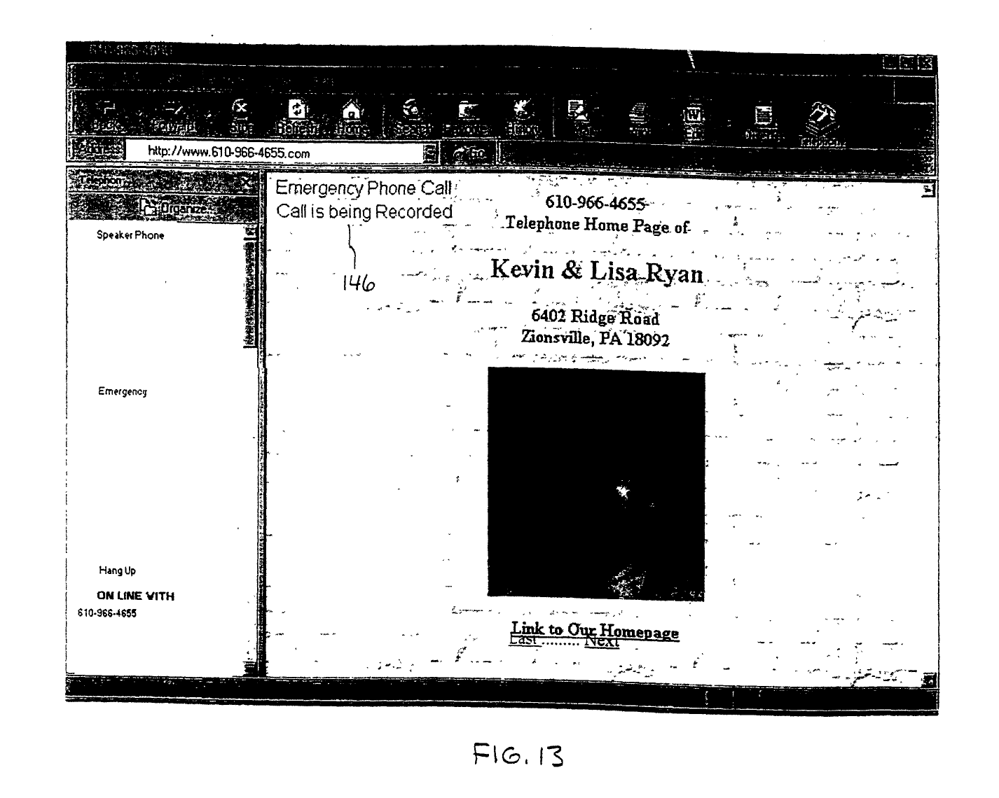

Emergency button 66 shown in FIG. 2 is provided so that in the event of an emergency, a caller can establish a connection with a called party's Internet telephone number or address, provided that the called party's computer is logged on or connected to the Internet at the time, even if the caller's number is not included on one of the screening lists. A preferred method of making an emergency call using the present invention in the network environment illustrated in FIG. 1 is outlined in the flowchart of FIG. 11 and implemented by the gatekeeper software program stored in the program memory of the computer 20. Even if a caller's telephone number is not on any of the lists compiled by the called party, the Emergency button 66 on the options menu 48 will still be active. When such caller 12 clicks on Emergency button 66, a screen will appear asking the caller 12 to enter his or her e-mail address. After such address is entered, the gatekeeper program will send a verification code 142 via e-mail 140 to the caller's e-mail address 144, as illustrated in FIG. 12. In addition, at the same time email 140 with verification code 142 is sent to caller 12, identity information can be removed from such caller's computer terminal and recorded. This procedure is preferred because it helps to deter caller's such as telemarketers or the like from using Emergency button 12 in non-emergency situations. Another option is for the ensuing emergency telephone conversation to also be automatically recorded by the gatekeeper program and stored on the called party's home computer. This fact may be displayed to the caller 12 on home page 38 as shown at 146 in FIG. 13. Therefore, if caller 12 is abusing the emergency function, hopefully sufficient information will have been gathered to identify the caller, which information can then be forwarded to the proper authorities in the case of a criminal act or the like.

After the access code 142 is received, caller 12 will again access home page 38 so that code can be entered in the designated area on the screen. Assuming the code is entered correctly, the call will then be connected with the called party. Access code 142 preferably will only be valid for a limited period of time, such as for twelve or twenty four hours, so that the caller 12 is prevented from repeatedly using the same access code over an extended period, and if it is transferred to another party by the caller, the code will shortly expire and access will again be restricted.

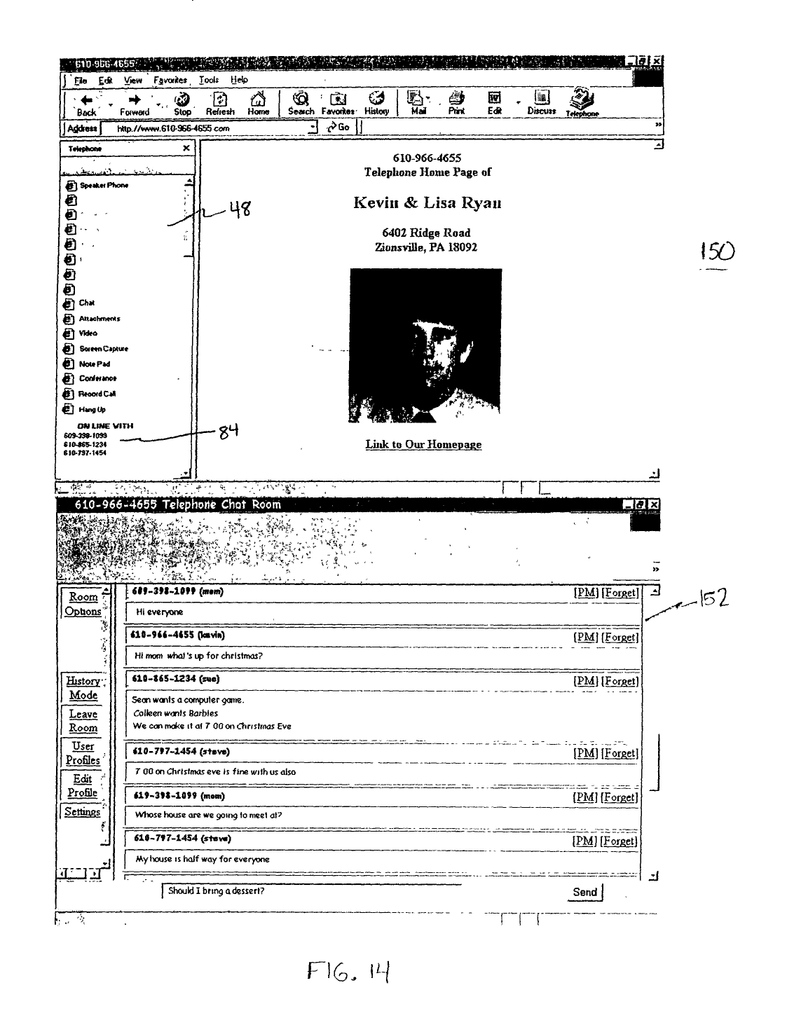

Chat 68 and Conference 78 features may also be controlled using the gatekeeper program. However, to ensure that the telephone home page owner retains control over all incoming telephone calls, it is preferred that such features can only be activated by the called party 14 upon receiving an incoming call. The chat feature would enable the home page owner to convert several calls into a chat session or chat room so that two or more parties can engage in real-time dialogue by typing messages to one another that will appear almost immediately on one another's computer screen. Such feature would be activated, for example, when it is desired for several callers to converse in almost real-time conversations, but where one party's Internet connection is not sufficient to handle calls from or between several parties at one time. Another instance when the chat feature might be activated is if one of the conversing parties is hearing impaired or deaf, so that it would be easier for such person to communicate via a chat session. The chat feature could also facilitate communication between parties that speak different languages, wherein a language translation program such as are known in the prior art would be incorporated into the gatekeeper program. For example, the chat screen could be split into two screens wherein the typed chat conversation is in a first language on one screen and in a second language on the second screen. FIG. 14 illustrates a typical chat room screen 152 attached to the bottom of screen 150. Regarding the conference feature, after an incoming call has been connected, the called party 14 could click on the Conference 78 button to add one or more additional callers to the telephone conversation. Additional call numbers 84 that are connected will preferably be listed at the bottom of the option menu 48.

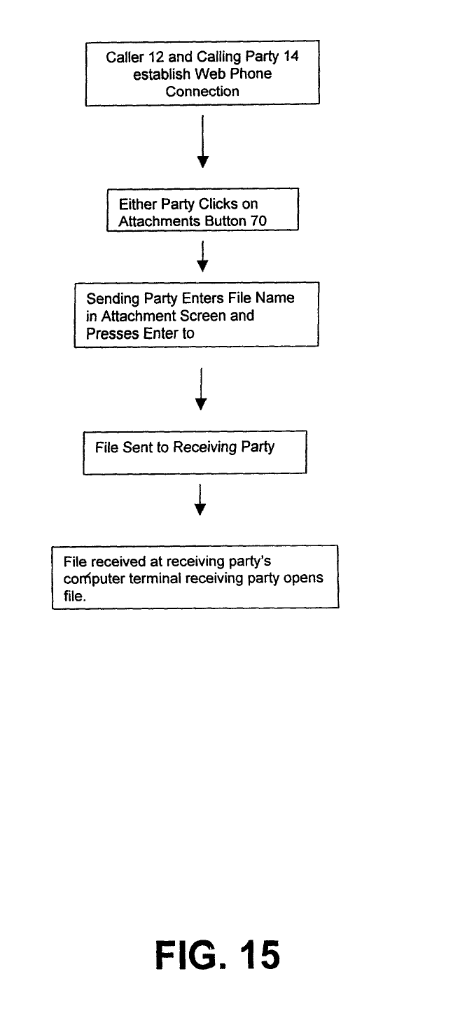

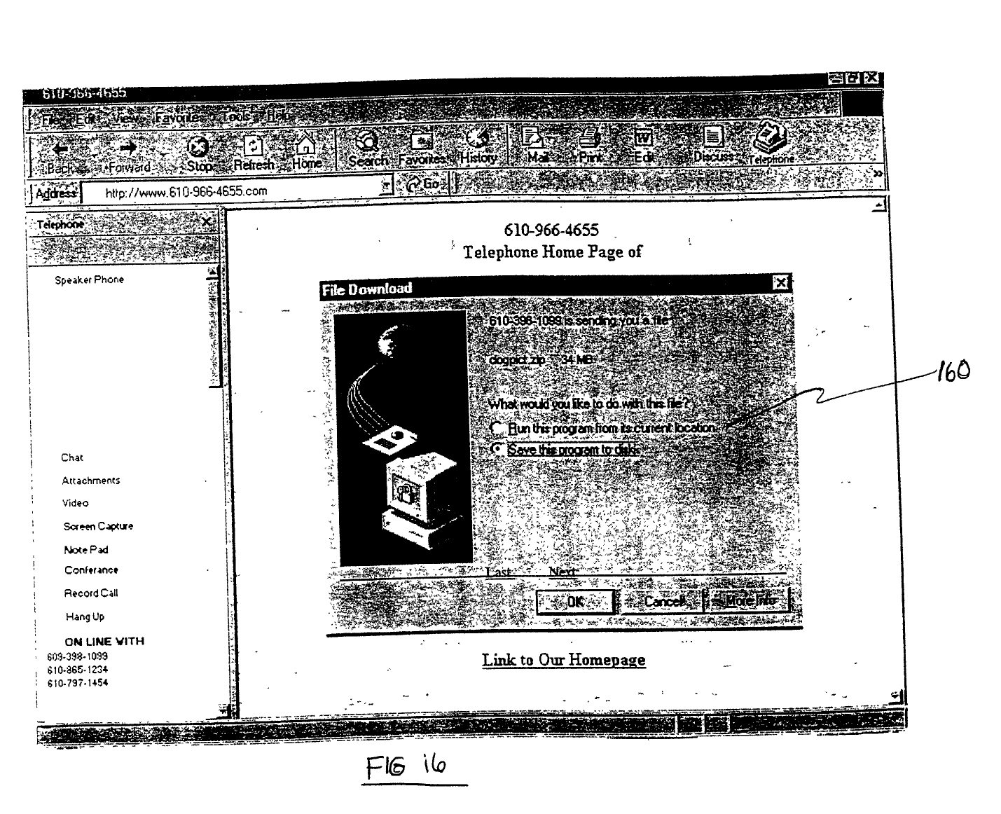

The Attachments button 70 allows either caller 12 or called party 14 to transfer or send an electronic file to the other party via the Internet during or in the middle of a web phone conversation without having to hang up the call or open another program, such as a separate e-mail program, to send the attachment. While users of the PSTN network having a single phone line and wishing to send a file will often first make a regular call to inform another that an e-mail or fax will be sent shortly, after which the party's would have to hang up so that the e-mail or fax could be sent and downloaded by the other party, and then reconnect the call if desired to discuss the contents of the file. Using the gatekeeper system, conversing parties having sufficient bandwidth can simply transfer the file via the Attachments button 70. FIG. 15 is a flow chart illustrating the steps involved in sending an attachment. After caller 12 and called party 14 have established a web phone connection as described above, if either party wishes to send the other party a file electronically, such party will click on the Attachments button 70. A screen will appear prompting the sending party to enter the name of the file or attachment to be sent to the receiving party's computer terminal. The sending party will enter the file name and, after verifying that the correct file name is listed, press enter or ok to send the file. Upon receipt of the file at the receiving party's computer terminal, but prior to the file being downloaded onto such terminal by the receiving party, a screen preferably will appear on the receiving party's computer terminal informing him or her that that an attachment has been received, the source and size of the file, and asking the receiving party how such attachment should be handled by the computer terminal. FIG. 16 illustrates a typical file download screen 160 using the gatekeeper system of a type used with the Microsoft Internet Explorer browser as is well known in the prior art, which asks the receiving party how he or she wishes to open the file, such as either by running the program from its current location or giving such file a file name and saving the program to a disk. While it is known to converse using a web phone and to at the same time send a file to one of such parties electronically, the gatekeeper program seamlessly integrates such options so that they can be performed simultaneously using the same program. Text, pictures, voice, music and other files could all be transferred using the attachments feature.

The Video button 72 allows parties having video capabilities such as streaming video to activate and control such features using the gatekeeper program. As is well known by those skilled in the art, streaming is a method of distributing particularly sound and/or video files over the Internet that permits the information to be viewed or heard as it is downloaded to a computer terminal, rather than waiting for the entire file to be downloaded. Playback then continues as long as the download process continues or until such process is interrupted. Most current streaming technology formats require software which can convert a standard video, audio, or multimedia computer file into a streaming format and software on the receiving computer terminal to permit playback of the formatted file. A current provider of streaming delivery systems and software is Macromedia, with its Shockzone system. If one of the parties wishes the other party to view a video such as a streaming video, which for example might be integrated into a video phone call by computers having a video camera and streaming video software installed, upon establishing a web phone connection one of the party's will click or press the Video button 72. A screen will then appear preferably below the home page screen or on a separate page on which the streaming video would be broadcast.

Screen Capture button 74 is preferably used to activate another feature of the gatekeeper program wherein pressing of button 74 allows either party to “capture” a screen on his or her computer. Such screen is then be displayed as a secondary window below the telephone home page on both party's computer screens. Each party is then able to point to particular sections or parts of the screen using his or her mouse, the movements of which mouse arrow would be visible on the other party's computer screen. Preferably, each party's mouse arrow is distinguishable from each other such as being in a different color. The screen capture feature may be quite useful in business situations wherein two parties may be discussing an engineering drawing or blueprint, so that the parties can now not only view the drawing on the computer screen while talking, but also can point to various portions of the drawing so that the other party can see where such party is pointing.

Note Pad button 76 is used to activate a note pad page so that notes of a phone conversation can be typed by either party. Preferably, upon activation of the note pad feature, caller id information, the date and time of the call, and other information recordable by the computer terminal will be automatically added to the header of each individual note pad file. Such file preferably can then be filed in a phone log folder. Alternatively, the Note Pad button 76 could be used to activate a party's e-mail capability, wherein notes would be taken in an e-mail file, and which file would then be sent to the user's e-mail address automatically when the user is finished entering information into the file.

Record Call button 80 is used to activate an option for recording of a web phone conversation. Upon pressing of the Record Call button 80 by the home page owner, a message will immediately appear on the caller's computer screen asking the caller if he or she would object to the home page owner recording the call. Preferably, the home page owner is able to control this command through the HTML coding limits programmed into the system. While the caller may also be given the option to record a call, such option is preferably restricted to be activated by the home page owner only. If a caller objects to being recorded, the call may either be continued by the home page owner or, if preferred, automatically disconnected. If a caller agrees to such recording, recorded calls preferably will be stored as digital files on the user's computer hard drive.

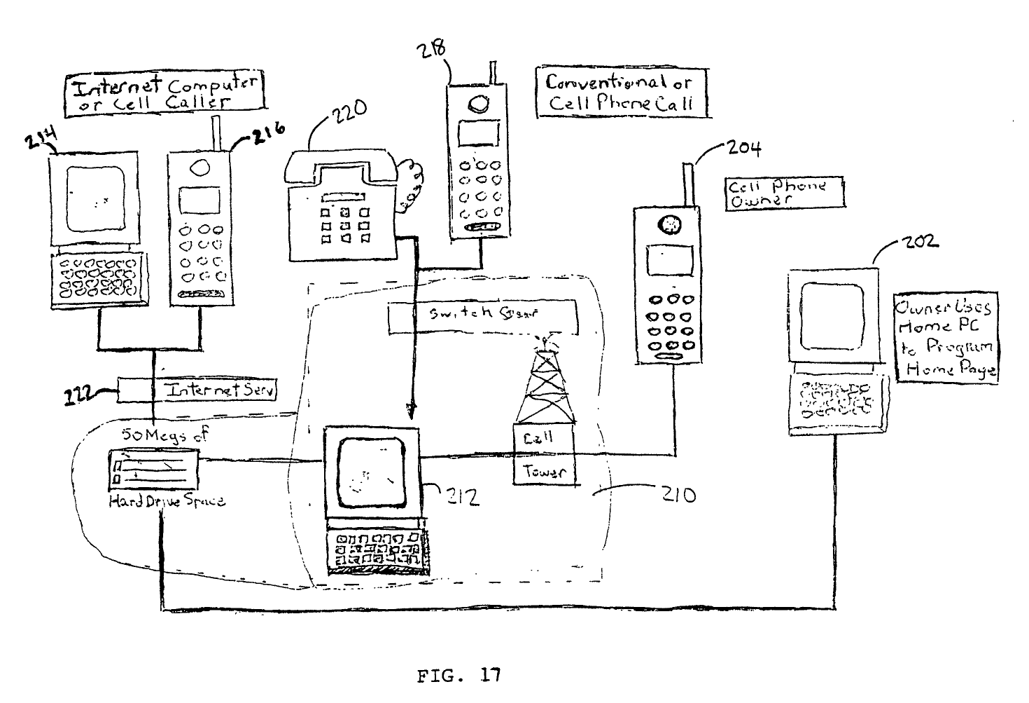

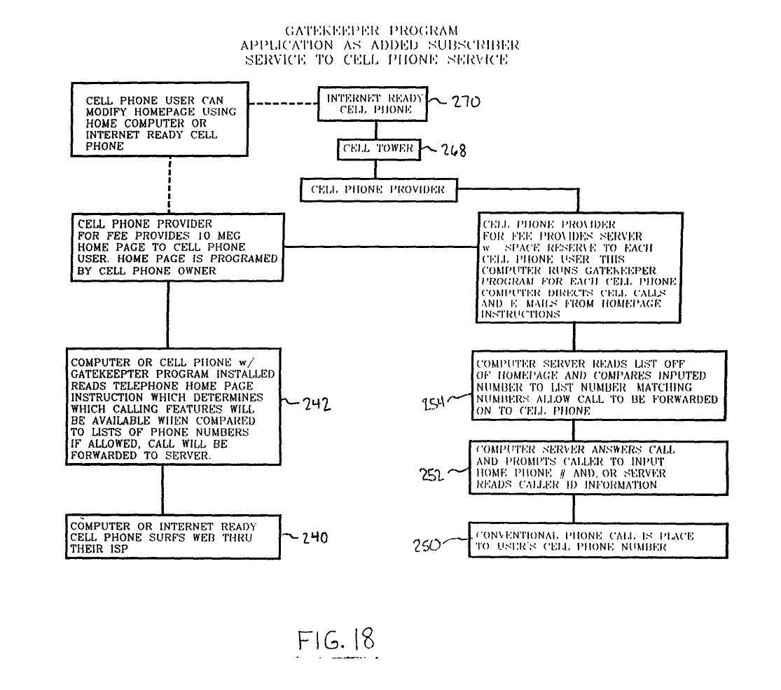

FIG. 17 is a schematic diagram illustrating an alternative embodiment of the present invention used as an added subscriber service in connection with a cellular telephone service, while FIG. 18 is a flowchart illustrating the essential steps in accomplishing such service. In such embodiment, a user will be able to modify his or her home page from either a home computer 202 or from an Internet ready cellular telephone 204. Both the home computer 202 and cellular telephone 204 use the gatekeeper program home page concept; however, in such embodiment, the homepage is located or stored on a cellular phone service provider's server, rather on the user's personal computer hard drive. By storing the home page and associated screening lists on the cellular phone service provider's servers rather than the owner's personal computer, such user will be able to update or access the home page from his or her Internet ready cellular telephone, regardless of whether such user's home computer is online or turned on. Such update is possible by providing a suitable program at the cell phone provider coded with respect to the cell phone of a subscriber in numerical code for access to the subscribers web page in the equipment of the phone provider. Once communication is established between the cell phone of the subscriber and the web page or other control of the cell phone provider, the subscriber can change the menu on the subscriber's web page using the lettered keys of the cell phone through any suitable software program. Since the cell phone has essentially the same keys as a computer, such communication as well as preparing suitable software is considerably facilitated. In addition, as explained below, the homepage screening lists essentially will always be turned on, since the servers 212 of the cellular service provider 210 will be required to be online at virtually all times. Therefore, callers calling from a personal computer 214, Internet cellular phone 216, regular cell phone 218 or conventional PSTN phone 220 will all have such calls routed to the called parties homepage on the cellular service provider's servers. Internet callers will connect with the Internet via an Internet Service Provider (ISP) 222 in the normal manner, which call is then routed to the homepage. The cell phone service provider 210 will, for a fee, provide such customer with a sufficient amount of server space 212 on a central server 214 on which each user's gatekeeper program can be stored and run. As indicated above, each user will program his or her personal telephone home page from a home PC 202. Cell phone calls and e-mails will be directed via the commands from the homepage in the same manner as the previously described embodiment, except that such homepage is located in the cellular phone provider's server. In other words, when a call or e-mail request is placed, the computer server reads the caller screening lists from the server and compare the inputted number of such caller with the lists. If a matching number is found, the call or e-mail will be forwarded to the cellular phone of the user; if not, the call will not be connected or the e-mail forwarded.

FIG. 18 further describes the workings of the embodiment outlined in FIG. 17. As shown in FIG. 18, a caller having a computer or an Internet ready cell phone (240) having software capable of communicating with the gatekeeper program installed will log on the Internet via his or her Internet Service Provider (ISP). Such call will be routed to a called party's telephone home page stored on the servers of the cellular telephone provider 260, wherein the calling features available to such caller will be determined using the screening lists described above (242). If the phone number input by the caller matches a number on one of lists of the called party, the associated calling features will be activated and the caller will be able to contact the cell phone owner's cell phone 270. On the other hand, if the caller's number does not match any of the numbers on the screening list, the call will not be routed to the called party's cell phone 270.

As also shown in FIG. 18, when a conventional PSTN call 250 is placed to a cellular phone number having a gatekeeper personal homepage, the call will be routed to the cellular phone server, which server as shown at 252 will immediately prompt the caller to input a home phone number or other caller id information. Once such information has been entered, as shown at 254 it is compared with the screening lists previously prepared by the user. As in previous embodiments, if the callers number matches one of the numbers on the screening list, the call will be forwarded to the user's cellular telephone through a cell tower 268 as known in the art.

It will be readily understood by those well versed in the operational characteristics of computers and software for programming and operating them that the provision of lists of code identification or other characteristics of potential communicants from which communications will be accepted and the provision of software for controlling the acceptance or rejection of or alternative connection with various acceptable alternative communication means by means of an electronic menu is well within the skill of the reasonably experienced software programmer and that the present invention resides in the methods and overall arrangements for establishing such communication and not the details of software for establishing such connections. Furthermore, the software for providing graphical interfaces such as web pages displayed on computer display terminals as home pages and the like is well known to web site designers, web site hosts, or their employees.

The advantages of the gatekeeper telephone home page concept over presently known systems are numerous. The system can be used with any business or home computer having a network connection capability. Creating a telephone home page can be done simply by any user, and preferably the gate keeper system will include step by step instructions for creating a basic telephone home page. Such program will also be used to compile the screening lists discussed above, as well as the e-mail codes of the user. While the system can be used with any domain name address, the inventor prefers at least initially that such addresses correspond or link to the user's conventional ten digit telephone number, since most new users of the system will be very familiar with such ten digit number system from the PSTN number identification system, and many of such user's important phone numbers will have already been committed to memory. It is believed that by drawing a direct relation between one's conventional PSTN telephone number and internet telephone home page address, consumers will more quickly begin to adopt use of a telephone home page in addition to and eventually replacing such conventional telephone. Even more preferably, a new top level domain name, such as .phn, may be established exclusively for use with telephone home page addresses in the present system, which would alleviate any confusion or disputes during adoption of the gatekeeper technology, thereby increasing consumer confidence and acceptance of the system. Consumers would merely be assigned the domain name address corresponding to their ten-digit phone number with the top level domain name .phn. New users without an existing telephone number would preferably be assigned a random number in the same area code within the area in which such person resides. More than one number could also point to the same telephone home page if desired. In addition, a directory of .phn addresses could also be included in the software of the present system, thereby making it easier to locate addresses of particular users without having to refer to a separate phone or domain name list outside of the gatekeeper program. The .phn directory may be easily updated by downloading such updated information from a web site in the usual manner.

Another advantage of the gatekeeper system is that it allows each telephone home page owner to have a single number by which all of a user's communications devices can be accessed. As shown above, the user's web phone, facsimile, pager, email, and cell phone can all be accessed from the same telephone number. In addition, the user can log into and use his or her phone number from any computer terminal, wherein the user can log into his or her Internet Service Provider. For example, a user on vacation or away from home on business can log into and receive phone calls to his or her home phone over the Internet, or update his or her screening lists as desired. Security features are also incorporated into the system, such as the option to digitally record conversations, and the ability to receive any phone call in an emergency irregardless if the caller's telephone number has been compiled on the corresponding screening list. The software of the gatekeeper system will also be easily compatible with existing computer hardware, and the web phone requires only the use of a standard sound card, microphone, and speakers. Such software will be easily integrated with a web browser as a plug-in, which plug-ins consumers and those skilled in the art are generally familiar with and which may be downloaded either from a disc or from a web site and self-installed to be usable from the web browser. In addition, the user does not have to subscribe to obtain many of the options available.

It will be understood that more than one call can be received at one time, depending upon the type of Internet connection the user has. For example, if the user has a DSL direct connection, a user could be conversing with a caller, while a second call is on hold. In such instance separate screens will be activated on the user's computer, with the active call screen in the foreground and with the screen for the call on hold in the background. Similar to a regular PSTN system, the first call can be placed on hold while a second call is activated, and vice versa. As many calls as can be handle by the telephone connection can be connected at the same time.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Claims

I claim:

1) A system for enabling a communicant to personally control one or more means of communication with outside parties via a digital data network comprising a graphical interface such as a web page on a computer display terminal, said graphical interface including a communications options menu from which the communicant can initiate a communication with another party connected to the digital data network using one of the communications options listed on said menu, and including a means by which the communicant can selectively control which communications options outside parties are able to use to establish a connection with the communicant.

2) The system for enabling a communicant to personally control one or more means of communication via the digital data network of claim 1 wherein said means for selectively controlling which communications options are available to an outside party comprises one or more lists of preprogrammed digital codes capable of identifying certain outside parties, each of said one or more lists being associated with one or more of said communications options, and wherein prior to the communications options menu being activated each outside party is required to supply a digital code, which code is compared with the lists or preprogrammed codes, and wherein if said code matches any of the preprogrammed codes the communications options associated with said lists will be activated.

3) The system for enabling a communicant to personally control one or more means of communication via the digital data network of claim 2 wherein if an outside party does not supply a code matching a code on one or more of the lists of preprogrammed codes, the communications options associated with said lists will be disabled with respect to further communication with said outside party.

4) The system for enabling a communicant to personally control one or more means of communication via a digital data network of claim 1 wherein said communications options menu includes a web phone option.

5) The system for enabling a communicant to personally control one or more means of communication via a digital data network of claim 1 wherein said communications options menu includes an answering machine option.

6) The system for enabling a communicant to personally control one or more means of communication via a digital data network of claim 1 wherein said communications options menu includes an e-mail option.

7) The system for enabling a communicant to personally control one or more means of communication via a digital data network of claim 1 wherein said communications options menu includes a pager option.

8) The system for enabling a communicant to personally control one or more means of communication via a digital data network of claim 1 wherein said communications options menu includes a cell phone option.

9) The system for enabling a communicant to personally control one or more means of communication via a digital data network of claim 1 wherein said communications options menu includes a facsimile option.

10) The system for enabling a communicant to personally control one or more means of communication via a digital data network of claim 1 wherein said communications options menu includes an emergency call option.

11) The system for enabling a communicant to personally control one or more means of communication via a digital data network of claim 1 wherein said communications options menu includes a chat option.

12) The system for enabling a communicant to personally control one or more means of communication via a digital data network of claim 1 wherein said communications options menu includes an attachments option.

13) The system for enabling a communicant to personally control one or more means of communication via a digital data network of claim 1 wherein said communications options menu includes a video option.

14) The system for enabling a communicant to personally control one or more means of communication via a digital data network of claim 1 wherein said communications options menu includes a screen capture option.

15) The system for enabling a communicant to personally control one or more means of communication via a digital data network of claim 1 wherein said communications options menu includes a note pad option.

16) The system for enabling a communicant to personally control one or more means of communication via a digital data network of claim 1 wherein said communications options menu includes a conference option.

17) The system for enabling a communicant to personally control one or more means of communication via a digital data network of claim 1 wherein said communications options menu includes a record call option.

18) A system for controlling communications via a digital data network comprising:
means for communicating over a data network;
graphical interface means;
a data storage device for entering and storing codes for identifying parties initiating a communication, said codes in addition being associated with one or more communications means,
means for determining if a party initiating a communication is one of those parties having a code associated with one or more of said communications means, and
means for allowing or blocking access to one or more of said communication means dependent upon whether or not the party initiating a communication has a code associated with one or more of said communication means.

19) A system for providing a called party control of access to a telephone address using a digital communications network comprising:
a) means for receiving an incoming call over a data network,
b) means for establishing the identity of certain callers,
c) means for determining if the incoming call is from one of said certain callers, and
d) means for allowing said certain callers to activate a calling option.

20) The system of claim 19 wherein the means for determining if the number of the incoming call is from one of said certain callers compares the number of the incoming call to a list of desired numbers.

21) The system of claim 20 wherein the list of desired numbers comprises numbers preprogrammed into the called party receiver.

22) The system of claim 19 wherein the list of desired numbers comprises numbers input into the system by the called party.

23) A method for providing control of telecommunications network services by a called party comprising the steps of: a) receiving an incoming call at a called party receiver from a calling party, b) identifying the incoming call, c) determining if the number of the incoming call originates from a source identified by a predetermined desired number, and d) answering the incoming call if the number of the incoming call is a desired number, wherein said step of answering the incoming call is performed automatically.

24) An incoming call filtering method comprising the steps of:
a) receiving an incoming call at a called party receiver from a calling party,
b) identifying the incoming call,
c) determining if the number of the incoming call originates from a source identified by a predetermined desired number, and
d) answering the incoming call if the number of the incoming call is a desired number, wherein said step of answering the incoming call is performed automatically.

25) A system for enabling a prospective communicant to limit communication with other communicants via a digital data network comprising a graphical interface established on a computer display terminal including a communications options menu incorporating a plurality of options for communications and including electronic switching means by which a preprogrammed list of options can be activated alternatively depending upon preprogrammed instructions associated with each of a menu of potential other communicants and wherein the options for each potential communicant listed comprise a series of options for potential communication in accordance with at least one of the following options:
(a) no communication authorized;
(b) communication established to a web phone option;
(c) communication established to an answering machine option;
(d) communication established via an e-mail option;
(e) communication established via a pager option;
(f) communication established via a cell phone option;
(g) communication established via an emergency call option;
(h) communication established via a chat room option dependent upon the communicants preprogramming of the system.

26) A system in accordance with claim 25 wherein more than one option is available in a predetermined order programmable by the communicant in which if communication is not established by a preferred means in accordance with the communicants preprogrammed options menu a next preferred option will be made available in serial order of preference.

27) A system in accordance with claim 25 wherein said digital data network is utilized in conjunction with a cellular telephone subscriber service.

28) A system in accordance with claim 27 wherein said preprogrammed lists of options and operating program are stored on a server controlled by the provider of said cellular telephone subscriber service.

29) A system in accordance with claim 28 wherein the communicant can access and amend access to such preprogrammed list of options using an Internet ready cellular telephone.
